(19) United States
(12) Patent Application Publication
(10) Pub. No.: US 2016/0377919 A1
(43) Pub. Date: Dec. 29, 2016

(54) Light Source Module, Backlight Module And Liquid Crystal Display Device Having The Light Source Module

(71) Applicant: SHENZHEN CHINA STAR OPTOELECTRONICS TECHNOLOGY CO., LTD., Shenzhen City, Guangdong (CN)

(72) Inventors: Chao NING, Shenzhen, Guangdong (CN); Chih-tsung KANG, Shenzhen, Guangdong (CN); Zuwei ZHANG, Shenzhen, Guangdong (CN)

(73) Assignee: Shenzhen China Star Optoelectronics Technology Co., Ltd., Shenzhen City, Guangdong (CN)

(21) Appl. No.: 14/889,228

(22) PCT Filed: Jun. 10, 2015
(86) PCT No.: PCT/CN2015/081182

§ 371 Date: Nov. 5, 2015

(30) Foreign Application Priority Data
Mar. 3, 2015 (CN) 201510094317.0

(51) Int. Cl. G02F 1/1335; G02F 1/1368

(52) U.S. Cl. CPC G02F 1/133603; G02F 1/133514; G02F 1/1368; G02F 2001/133612

(57) ABSTRACT

A light source module comprises a substrate, light emitting components arranged in an array on the substrate, an internal wiring portion formed on the substrate and connected to the light emitting components, an external wiring portion formed on the substrate and isolated from the internal wiring portion, a first connecting unit formed on a first side of the substrate and connected to the external wiring portion and a second connection unit formed on a second side of the substrate and connected to the internal and the external wiring portion. The disclosure reduces the number of the leads required for the light source module when installing the light source module into the backlight module. The disclosure simplifies the assembly process, and reduces production costs. Further, the occupied areas of the leads in the backlight module are reduced to improve space utilization in the backlight module.

### BACKGROUND

Technical Field

The disclosure is related to the technology field of the liquid crystal display, and more particular to a light source module, a backlight module and a liquid crystal display device having the light source module.

Related Art

With the development of the information society, the demand for flat panel displays is rapidly growing. Liquid Crystal Display (abbreviated LCD) Devices with the characteristics of small size, low power consumption, and no radiation dominates in the current flat-panel display market. However, LCD does not emit light itself and requires other light-emitting devices to provide a light source. Therefore, a backlight module for providing a light source is configured at the backside of the LCD panel.

Generally, the point light source such as LED is used as the light source of the backlight module.

In recent years the size of the liquid crystal display is increasing. When the backlight module with LED light source is applied to large-sized LCD, the prior art generally installs a plurality of LED on a plurality of substrates to form the light source module of the backlight module. However, when such light source modules are installed on the backlight module, it requires a larger number of connecting leads, which results in cumbersome assembly. Further, a larger number of connecting leads occupy larger space of the backlight module such that the space for other components of the backlight module is insufficient.

### SUMMARY

In order to solve the problem existing in the current technology, the object of the disclosure provides a light source module comprising a substrate, a plurality of light emitting components arranged in an array on the substrate, an internal wiring portion formed on the substrate and connected to the plurality of light emitting components, an external wiring portion formed on the substrate and isolated from the internal wiring portion, a first connecting unit formed on a first side of the substrate and connected to the external wiring portion, and a second connection unit formed on a second side of the substrate and connected to the internal wiring portion and the external wiring portion.

In one embodiment, the plurality of light emitting components comprises one or more light emitting diodes.

In one embodiment, the internal wiring portion comprises a first internal lead for connecting to the light emitting diodes connected in series in each row, a second internal lead for connecting the positive electrode of the light emitting diodes connected in series in each row to the internal positive electrode of the second connecting unit, and a third internal lead for connecting the negative electrode of the light emitting diodes connected in series in each row to the internal negative electrode of the second connecting unit.

In one embodiment, the external wiring portion comprises a first external lead for connecting the internal positive electrode of the first connecting unit to the external positive electrode of the second connecting unit, and a second external lead for connecting the internal negative electrode of the first connection unit to the external negative electrode of the second connecting unit.

Another object of the disclosure is to provide a backlight module comprising a plurality of light source modules mentioned above. The light source modules are arranged in rows or in columns, and the plurality of light source modules electrically connected with each other.

In one embodiment, the internal positive electrode of the second connecting unit in each light source module is connected to the internal positive electrode of the first connecting unit in the adjacent light source module, and the internal negative electrode of the second connecting unit in each light source module is connected to the internal negative electrode of the first connecting unit in the adjacent light source module.

In one embodiment, the external positive electrode and the internal positive electrode of the second connecting unit of the last light source module of the plurality of light source modules arranged in a row or in a column is connected to the positive electrode of the power source, and the external negative electrode and the internal negative electrode of the second connecting unit of the last light source module of the plurality of light source modules arranged in a row or in a column is connected to the negative electrode of the power source.

Another object of the disclosure is to provide a liquid crystal display device comprising the backlight module mentioned above and a liquid crystal display panel arranged opposite to the backlight module. The backlight module providing display light source to the liquid crystal display panel such that the liquid crystal display panel displays an image.

In one embodiment, the liquid crystal display panel comprises a thin film transistor array substrate, a color filter substrate arranged opposite to the thin film transistor array substrate, and a liquid crystal layer sandwiched between the thin film transistor array substrate and the color filter substrate.

The disclosure reduces the number of the leads required for the light source module when installing the light source module into the backlight module. The disclosure simplifies the assembly process, and reduces production costs. Further, the occupied areas of the leads in the backlight module are reduced to improve space utilization in the backlight module.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is the schematic diagram of the light source module of the embodiment of the disclosure;

FIG. 2 is the schematic diagram of the backlight module of the embodiment of the disclosure; and

FIG. 3 is the schematic diagram of the liquid crystal display device of the embodiment of the disclosure.

### DETAILED DESCRIPTION

The following description with reference to the accompanying drawings is provided to explain the exemplary embodiments of the disclosure. It will be apparent, however, that the disclosure may be practiced by one or more embodiments, and the specific embodiments provided herein cannot be interpreted to limit the disclosure. On the contrary, those embodiments are provided to explain the principle and the application of the disclosure such that those skilled in the art may understand the various embodiments of the disclosure and the various modifications for specific expected application. In the drawings, in order to clearly illustrate the components, the thickness of layers and regions are exaggerated. The same reference numerals throughout the specification and drawings can be used to denote the same elements.

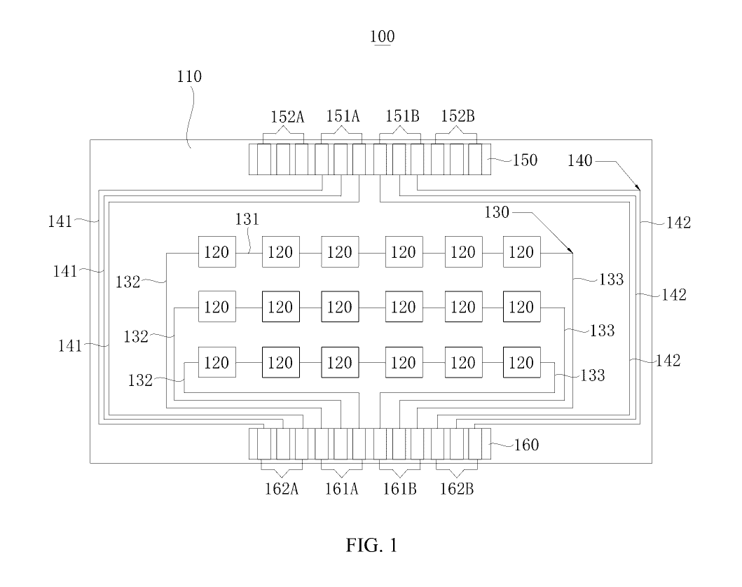

FIG. 1 is the schematic diagram of the light source module of the embodiment of the disclosure.

Refer to FIG. 1. The light source module 100 of the embodiment of the disclosure comprises a substrate 110, a plurality of light emitting components (such as LED) 120, an internal wiring portion 130, an external wiring portion 140, a first connecting unit 150 and a second connection unit 160.

The plurality of light emitting components is arranged in an array on the substrate 110. In FIG. 1, eighteen LEDs 120 in three rows and six columns are illustrated. But the disclosure is not limited to the amount. For example, the amount of LED 120 may be determined according to the actual requirement.

The internal wiring portion 130 is formed on the substrate 110 and is connected to the plurality of LED 120. Each internal wiring portion 130 comprises a plurality of leads. For example, the number of the leads may be determined according to the amount of the LED 120. In this embodiment, there are three internal wiring portions 130 formed on the substrate 110. Each internal wiring portion 130 comprises a first internal lead 131 for connecting to the light emitting diodes 120 connected in series in each row, a second internal lead 132 for connecting the positive electrode of the light emitting diodes 120 connected in series in each row to the internal positive electrode 161A of the second connecting unit 160, and a third internal lead 133 for connecting the negative electrode of the light emitting diodes 120 connected in series in each row to the internal negative electrode 161B of the second connecting unit.

The external wiring portion 140 is formed on the substrate 110 and the external wiring portion 140 is electrically isolated from the internal wiring portion 130. Each external wiring portion 140 comprises a plurality of leads. For example, the number of the leads may be determined according to the amount of the LED 120. In this embodiment, there are three external wiring portions 140 formed on the substrate 110. Each external wiring portion 140 comprises a first external lead 141 for connecting the internal positive electrode 151A of the first connecting unit 150 to the external positive electrode 162A of the second connecting unit 160, and a second external lead 142 for connecting the internal negative electrode 151B of the first connection unit 150 to the external negative electrode 162B of the second connecting unit 160.

The first connecting unit 150 comprises six positive electrodes and six negative electrodes formed on one side of the substrate 110. These six positive electrodes are divided as three internal positive electrodes 151A and three external positive electrodes 152A according to the electrical connection with LED 120, where three internal positive electrodes 151A connect to the positive electrodes of the three rows of LEDs 120 connected in series. Similarly, these six negative electrodes are divided as three internal negative electrodes 151B and three external negative electrodes 152B according to the electrical connection with LED 120, where three internal negative electrodes 151B connect to the negative electrodes of the three rows of LEDs 120 connected in series. In this disclosure, the amount of the positive electrode and the negative electrode of the first connecting unit 150 may be determined according to the amount of LED 120. The three internal positive electrodes 151A of the first connecting unit 150 are respectively connected to the three external positive electrodes 162A of the second connecting unit 160. The three internal negative electrodes 151B of the first connecting unit 150 are respectively connected to the three external negative electrodes 162B of the second connecting unit 160. The three external positive electrodes 152A of the first connecting unit 150 and the three external negative electrodes 152B of the first connecting unit 150 are open.

The second connecting unit 150 comprises six positive electrodes and six negative electrodes formed on the other side of the substrate 110. These six positive electrodes are divided as three internal positive electrodes 161A and three external positive electrodes 162A according to the electrical connection with LED 120, where three internal positive electrodes 161A connect to the positive electrodes of the three rows of LEDs 120 connected in series. Similarly, these six negative electrodes are divided as three internal negative electrodes 161B and three external negative electrodes 162B according to the electrical connection with LED 120, where three internal negative electrodes 161B connect to the negative of the three rows of LEDs 120 connected in series. In this disclosure, the amount of the positive electrode and the negative electrode of the second connecting unit 160 may be determined according to the amount of LED 120. The three internal positive electrodes 161A of the second connecting unit 160 are respectively connected to the positive electrodes of the three rows of LED 120 connected in series. The three internal negative electrodes 161B of the second connecting unit 160 are respectively connected to the negative electrodes of the three rows of LED 120 connected in series. Further, the internal positive electrodes 161A and the three external positive electrodes 162A of the second connecting unit 160 are connected to a positive electrode of an external power source (not shown). The internal negative electrodes 161B and the three external negative electrodes 162B of the second connecting unit 160 are connected to a negative electrode of the external power source.

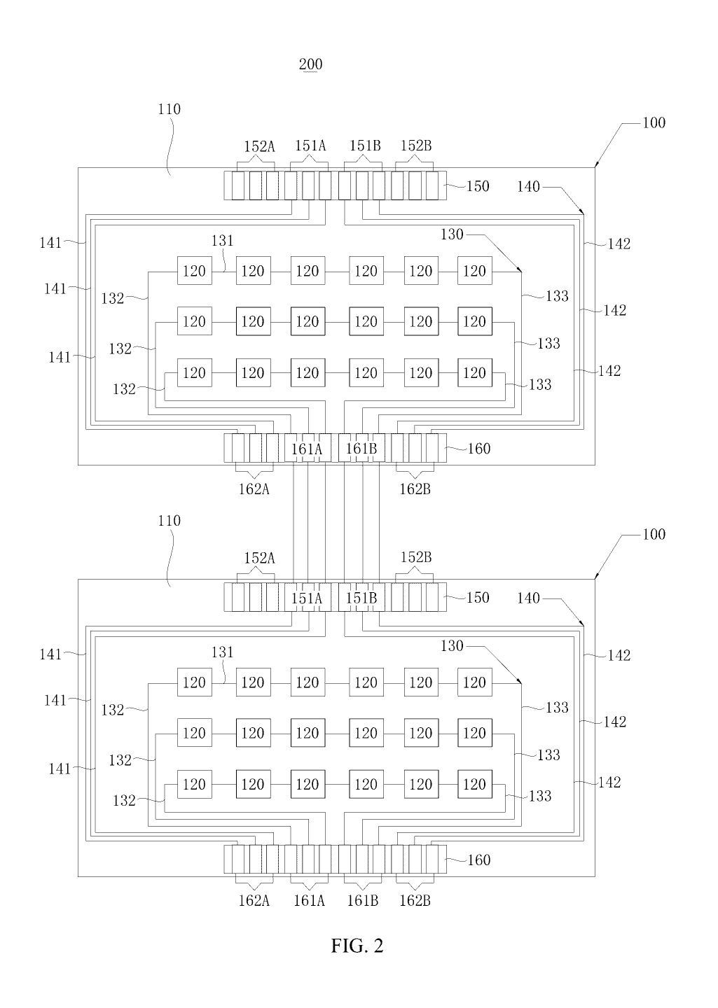

FIG. 2 is the schematic diagram of the backlight module of the embodiment of the disclosure.

Refer to FIG. 2. The backlight module 200 of the embodiment of the disclosure comprises a plurality of the light source modules 100 of FIG. 1. These light source modules 100 are arranged in rows or in columns and the plurality of light source modules 100 electrically connected with each other. It should be noted that the backlight module 200 of the embodiment of the disclosure further comprises other necessary optical components such as a back plate, optical film, and etc. The specific details may refer to the description of the prior art, and are not repeated again.

FIG. 2 illustrates two light source modules 100 of FIG. 1 arranged in a row, but the disclosure is not limited to this arrangement. The amount of the light source module 100 may be determined according to the actual requirement. Further, it should be noted that according to the actual requirement, the backlight module 200 of the embodiment of the disclosure may comprises a plurality of the light source module combination composed of two light source modules 100 as shown in FIG. 2. For example, these light source module combination may be arranged in a row direction.

Furthermore, the three internal positive electrodes 161A of the second connecting unit 160 of the upper light source module 100 are correspondingly connected to the three internal positive electrodes 151A of the first connecting unit 150 of the lower light source module 100. The three internal negative electrodes 161B of the second connecting unit 160 of the upper light source module 100 are correspondingly connected to the three internal negative electrodes 151B of the first connecting unit 150 of the lower light source module 100.

Furthermore, the three internal positive electrodes 161A and the three external positive electrodes 162A of the second connecting unit 160 of the last light source module (that is the lower light source module 100) of these two light source modules 100 arranged in the row direction are connected to the positive electrode of the external power source, and the three internal negative electrodes 161B and the three external positive electrodes 162B of the second connecting unit 160 of the last light source module are connected to the negative electrode of the external power source.

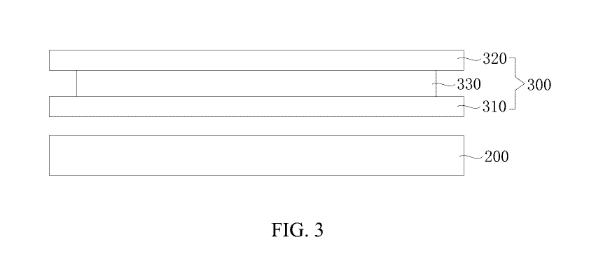

FIG. 3 is the schematic diagram of the liquid crystal display device of the embodiment of the disclosure.

Refer to FIG. 3. The liquid crystal display device of the embodiment of the disclosure comprises a liquid crystal display panel 300 and the backlight module 200 as shown in FIG. 2 arranged opposite to the liquid crystal display panel 300. The backlight module 200 provides display light to the liquid crystal display panel 300 such that the liquid crystal display panel 300 may display an image.

The liquid crystal display panel 300 generally comprises a thin film transistor array substrate 310, a color filter (CF) substrate 320 arranged opposite to the thin film transistor array substrate 310, and a liquid crystal layer 330 sandwiched between the thin film transistor array substrate 310 and the color filter substrate 320. The liquid crystal layer 330 comprises liquid crystal molecules. Because the specific structure of the liquid crystal display panel 300 of the disclosure is substantially the same as that of the liquid crystal display panel of the prior art, the description is not repeated again.

Accordingly, the embodiments of the disclosure reduce the number of the leads required for the light source module when installing the light source module into the backlight module. The embodiments of the disclosure simplify the assembly process, and reduce production costs. Further, the occupied areas of the leads in the backlight module are reduced to improve space utilization in the backlight module.

Although the present disclosure is illustrated and described with reference to specific embodiments, those skilled in the art will understand that many variations and modifications are readily attainable without departing from the spirit and scope thereof as defined by the appended claims and their legal equivalents.

What is claimed is:

1. A light source module, comprising:
a substrate;
a plurality of light emitting components arranged in an array on the substrate;
an internal wiring portion formed on the substrate and connected to the plurality of light emitting components;
an external wiring portion formed on the substrate and isolated from the internal wiring portion;
a first connecting unit formed on a first side of the substrate and connected to the external wiring portion; and
a second connection unit formed on a second side of the substrate and connected to the internal wiring portion and the external wiring portion.

2. The light source module according to claim 1, wherein the plurality of light emitting components comprises one or more light emitting diodes.

3. The light source module according to claim 1, wherein the internal wiring portion comprises a first internal lead for connecting to the light emitting diodes connected in series in each row, a second internal lead for connecting the positive electrode of the light emitting diodes connected in series in each row to the internal positive electrode of the second connecting unit, and a third internal lead for connecting the negative electrode of the light emitting diodes connected in series in each row to the internal negative electrode of the second connecting unit.

4. The light source module according to claim 1, wherein the external wiring portion comprises a first external lead for connecting the internal positive electrode of the first connecting unit to the external positive electrode of the second connecting unit, and a second external lead for connecting the internal negative electrode of the first connection unit to the external negative electrode of the second connecting unit.

5. A backlight module comprising a plurality of light source modules arranged in rows or in columns, and the plurality of light source modules electrically connected with each other, the light source module comprising:
a substrate;
a plurality of light emitting components arranged in an array on the substrate;
an internal wiring portion formed on the substrate and connected to the plurality of light emitting components;
an external wiring portion formed on the substrate and isolated from the internal wiring portion;
a first connecting unit formed on a first side of the substrate and connected to the external wiring portion; and
a second connection unit formed on a second side of the substrate and connected to the internal wiring portion and the external wiring portion.

6. The backlight module according to claim 5, wherein the plurality of light emitting components comprises one or more light emitting diodes.

7. The backlight module according to claim 5, wherein the internal wiring portion comprises a first internal lead for connecting to the light emitting diodes connected in series in each row, a second internal lead for connecting the positive electrode of the light emitting diodes connected in series in each row to the internal positive electrode of the second connecting unit, and a third internal lead for connecting the negative electrode of the light emitting diodes connected in series in each row to the internal negative electrode of the second connecting unit.

8. The backlight module according to claim 5, wherein the external wiring portion comprises a first external lead for connecting the internal positive electrode of the first connecting unit to the external positive electrode of the second connecting unit, and a second external lead for connecting the internal negative electrode of the first connection unit to the external negative electrode of the second connecting unit.

9. The backlight module according to claim 5, wherein the internal positive electrode of the second connecting unit in each light source module is connected to the internal positive electrode of the first connecting unit in the adjacent light source module, and the internal negative electrode of the second connecting unit in each light source module is connected to the internal negative electrode of the first connecting unit in the adjacent light source module.

10. The backlight module according to claim 5, wherein the external positive electrode and the internal positive electrode of the second connecting unit of the last light source module of the plurality of light source modules arranged in a row or in a column is connected to the positive electrode of the power source, and the external negative electrode and the internal negative electrode of the second connecting unit of the last light source module of the plurality of light source modules arranged in a row or in a column is connected to the negative electrode of the power source.

11. A liquid crystal display device comprising a backlight module and a liquid crystal display panel arranged opposite to the backlight module, the backlight module providing display light source to the liquid crystal display panel such that the liquid crystal display panel displays an image, wherein the backlight module comprising a plurality of light source modules arranged in rows or in columns, and the plurality of light source modules electrically connected with each other, the light source module comprising:
a substrate;
a plurality of light emitting components arranged in an array on the substrate;
an internal wiring portion formed on the substrate and connected to the plurality of light emitting components;
an external wiring portion formed on the substrate and isolated from the internal wiring portion;
a first connecting unit formed on a first side of the substrate and connected to the external wiring portion; and
a second connection unit formed on a second side of the substrate and connected to the internal wiring portion and the external wiring portion.

12. The liquid crystal display device according to claim 11, wherein the plurality of light emitting components comprises one or more light emitting diodes.

13. The liquid crystal display device according to claim 11, wherein the internal wiring portion comprises a first internal lead for connecting to the light emitting diodes connected in series in each row, a second internal lead for connecting the positive electrode of the light emitting diodes connected in series in each row to the internal positive electrode of the second connecting unit, and a third internal lead for connecting the negative electrode of the light emitting diodes connected in series in each row to the internal negative electrode of the second connecting unit.

14. The liquid crystal display device according to claim 11, wherein the external wiring portion comprises a first external lead for connecting the internal positive electrode of the first connecting unit to the external positive electrode of the second connecting unit, and a second external lead for connecting the internal negative electrode of the first connection unit to the external negative electrode of the second connecting unit.

15. The liquid crystal display device according to claim 11, wherein the internal positive electrode of the second connecting unit in each light source module is connected to the internal positive electrode of the first connecting unit in the adjacent light source module, and the internal negative electrode of the second connecting unit in each light source module is connected to the internal negative electrode of the first connecting unit in the adjacent light source module.

16. The liquid crystal display device according to claim 11, wherein the external positive electrode and the internal positive electrode of the second connecting unit of the last light source module of the plurality of light source modules arranged in a row or in a column is connected to the positive electrode of the power source, and the external negative electrode and the internal negative electrode of the second connecting unit of the last light source module of the plurality of light source modules arranged in a row or in a column is connected to the negative electrode of the power source.

17. The liquid crystal display device according to claim 11, wherein the liquid crystal display panel comprises a thin film transistor array substrate, a color filter substrate arranged opposite to the thin film transistor array substrate, and a liquid crystal layer sandwiched between the thin film transistor array substrate and the color filter substrate.
